(19) United States
(12) Patent Application Publication
(10) Pub. No.: US 2025/0296355 A1
(43) Pub. Date: Sep. 25, 2025

(54) INTEGRATED THERMAL DYE SUBLIMATION PRINTING AND FILM-CUTTING MACHINE

(71) Applicant: HANNTO TECHNOLOGY CO., LTD., Shanghai (CN)

(72) Inventor: Feng WANG, Shanghai (CN)

(21) Appl. No.: 18/937,095

(22) Filed: Nov. 5, 2024

Related U.S. Application Data
(63) Continuation of application No. PCT/CN2024/094257, filed on May 20, 2024.

(30) Foreign Application Priority Data
Mar. 25, 2024 (CN) 202410345104.X
Mar. 25, 2024 (CN) 202420590412.4

(51) Int. Cl. B41J 3/44; B32B 37/00; B32B 38/00; B41J 11/00; B41J 11/70; B41J 13/03; B41J 29/13

(52) U.S. Cl. CPC B41J 3/44; B32B 37/0053; B32B 38/0004; B32B 38/145; B41J 11/0095; B41J 11/70; B41J 13/03; B41J 29/13

(57) ABSTRACT

An integrated thermal dye sublimation printing and film-cutting machine includes a housing with a printing assembly and a film-cutting assembly inside, a first end in the housing close to the printing assembly is rotatably provided with two transfer rollers for printing, which are rotated by an actuator for printing, and a second end in the housing close to the film-cutting assembly is rotatably provided with two transfer rollers for film-cutting, which are rotated by an actuator for film-cutting, a shortest distance between the transfer rollers for printing and the transfer rollers for film-cutting is less than a length of a paper, a paper inlet is defined at the first end, a paper outlet is defined at the second end, and the paper successively enters between the two transfer rollers for printing and between the two transfer rollers for film-cutting through the paper inlet, and move out through the paper outlet.

### CROSS-REFERENCE TO RELATED APPLICATION

This application is a continuation of PCT application serial no. PCT/CN2024/094257, filed on May 20, 2024, which claims the priority and benefit of Chinese patent application serial no. 202410345104.X, filed on Mar. 25, 2024, and Chinese patent application serial no. 202420590412.4, filed on Mar. 25, 2024. The entireties of PCT application serial no. PCT/CN2024/094257, Chinese patent application serial no. 202410345104.X, and Chinese patent application serial no. 202420590412.4 are hereby incorporated by reference herein and made a part of this specification.

### TECHNICAL FIELD

The present application relates to the field of integrated printing and film-cutting technology, and in particular, to an integrated thermal dye sublimation printing and film-cutting machine.

### BACKGROUND ART

A thermal dye sublimation printer is a common office equipment that uses thermal energy to transfer pigments to a paper for color printing, after which the paper may be fully laminated with film. A film cutter, also called a film-cutting machine, is an intelligent device configured to measure the phone, and cut and paste film on site in such places as DIY cultural and creative store, mobile phone store, accessories store and maintenance store.

The film-cutting machine is often used in combination with a printer. The paper processed by the printer includes a base paper and a lamination film adhered to the base paper. In this case, the film-cutting machine shall carry out die cutting on the lamination film in operation to form the required shape and specification. The printer and the film-cutting machine in existing technique are two separate devices, which need to occupy separate and different spaces. When the user's site is limited, the separated printer and film-cutting machine bring severe inconvenience to the user due to necessary larger space.

### SUMMARY

In order to improve the situation that the separated printer and film-cutting machine in existing technique bring severe inconvenience to the user due to necessary larger space, the present application provides an integrated thermal dye sublimation printing and film-cutting machine.

The integrated thermal dye sublimation printing and film-cutting machine provided in the present application adopts the following technical solutions.

An integrated thermal dye sublimation printing and film-cutting machine includes a housing, a printing assembly and a film-cutting assembly are provided in the housing, an end in the housing close to the printing assembly is rotatably provided with two transfer rollers for printing, an actuator for printing is provided in the housing to rotate the transfer rollers for printing, and an end in the housing close to the film-cutting assembly is rotatably provided with two transfer rollers for film-cutting, an actuator for film-cutting is provided in the housing to rotate the transfer rollers for film-cutting, a shortest distance between the transfer rollers for printing and the transfer rollers for film-cutting is less than a length of a paper, a paper inlet is defined at the end in the housing close to the printing assembly, a paper outlet is defined at the end in the housing close to the film-cutting assembly, and the paper is configured to successively enter between the two transfer rollers for printing and between the two transfer rollers for film-cutting through the paper inlet, and move out through the paper outlet.

By using the above-mentioned technical solution, when it is required to print and perform the film-cutting process on the paper, the paper is fed into the housing through the paper inlet, such that the end of the paper enters between the two transfer rollers for printing. Then the two transfer rollers for printing are driven to rotate by the actuator for printing, such that the clamping and conveying of the paper are realized by the rotation of the two transfer rollers for printing. The printing assembly runs to print and laminate a film on the paper during the conveyance of the paper. By the above-mentioned process, a movement direction of the paper may be changed by changing the rotation direction of the transfer rollers for printing, so that the paper is fed in and out to complete a reciprocating movement, and the printing assembly thus may perform multi-step operations on the paper to complete the printing and the film lamination of the paper.

After the printing and film lamination of the paper are completed, the transfer rollers for printing rotate to move the paper toward the transfer rollers for film-cutting, and when the end of the paper arrives between the two transfer rollers for film-cutting, the actuator for film-cutting drives the transfer rollers for film-cutting to rotate, and the clamping and conveying of the paper are realized by the rotation of the transfer rollers for film-cutting, whereby the paper moves in the direction close to the film-cutting assembly, and then the film-cutting assembly runs to perform the film-cutting process on the paper. As the film-cutting assembly runs, the end of the paper leaves the transfer rollers for printing. The movement direction of the paper may be changed by changing the rotation direction of the transfer rollers for film-cutting, such that the paper may be moved out and in through the paper outlet so as to perform a reciprocating movement, and the film-cutting assembly may perform multi-step operations on the paper, thereby completing the film-cutting process of the paper.

After both the printing and the film-cutting process of the paper are completed, the transfer rollers for film-cutting rotate, to move the paper out of the paper outlet, thereby completing all the processing of the paper. Since the shortest distance between the transfer rollers for printing and the transfer rollers for film-cutting is less than the length of the paper, the paper does not leave the transfer rollers for printing and/or the transfer rollers for film-cutting during the entire conveyance of the paper, whereby a stable conveyance of the paper is achieved, which prevents the paper from falling into the housing.

The printing assembly and the film-cutting assembly are integrated together by the integrated machine of the present application, and the printing and film-cutting process of the paper may be completed by the integrated machine. The integrated machine has a compact structure and occupies a small space, and is flexible and convenient to use. Under the premise that the user's field is limited, the use requirements may still be satisfied and the inconvenience caused to the user due to a restricted space may be avoided. In addition, when the paper only needs to be printed or undergo a film-cutting processing separately, which may be achieved by the integrated machine with high overall applicability.

Optionally, a partition plate is provided in the housing, the partition plate divides a space in the housing into a first channel and a second channel, the printing assembly and the transfer rollers for printing are located in the first channel, a first guide plate is obliquely provided on the partition plate, and the first guide plate is widened to an end close to the film-cutting assembly.

By using the above-mentioned technical solution, the partition plate divides the space in the housing, so that the printing assembly and the transfer rollers for printing are located in the first channel, and when the printing assembly performs a printing processing on the paper, the paper moves in the first channel. When the printing processing on the paper is completed, the transfer rollers for film-cutting rotate to reciprocate the paper, so that the film-cutting assembly performs a film-cutting operation. As the paper moves in and out through the paper outlet, the paper is guided into the second channel by the first guide plate. The second channel provides a clean path for the paper to avoid interference on the paper by the printing assembly and transfer rollers for printing during film-cutting.

Optionally, a second guide plate is provided in the first channel, one end of the second guide plate extends obliquely in a direction close to the printing assembly, and the other end of the second guide plate extends in a same inclined direction as that of the first guide plate and extends obliquely to the film-cutting assembly.

By using the above-mentioned technical solution, two ends of the second guide plate which are obliquely provided may respectively guide the paper in two movement directions. After the printing process of the paper is finished, the transfer rollers for printing move the paper in the direction close to the film-cutting assembly, in this process, the end of the paper will come into contact with the second guide plate, such that the paper may more smoothly abut against the transfer rollers for film-cutting under the guidance of the second guide plate. When the paper is subjected to the film-cutting process, an end of the second guide plate close to the film-cutting assembly cooperates with the first guide plate to better guide the paper, which is convenient for the paper to enter into the second channel.

Optionally, a top plate is provided in the first channel, and the top plate is located between the transfer rollers for printing and the transfer rollers for film-cutting.

By using the above-mentioned technical solution, the top plate is configured to restrict the movement direction of the paper. When the paper moves in the direction close to the transfer rollers for printing, in the case that the paper moves into the first channel by mistake, the end of the paper will abut against the top plate, the top plate limits the continued movement of the paper in the same direction, and the end of the paper will deform itself after abutting against the top plate without continuing to move in the direction towards the transfer rollers for printing, so as to further avoid interference on the paper by the transfer rollers for printing during film-cutting.

Optionally, an access opening is defined at the housing, the access opening is located between the printing assembly and the film-cutting assembly, and a cover plate is detachably connected to the housing to close the access opening.

By using the above-mentioned technical solution, the provision of the access opening facilitates timely overhaul and maintenance of various components in the housing, and when a paper jam occurs accidentally in the housing, the paper may also be taken out through the access opening, so that the working convenience of the integrated machine is improved thereby. During the daily operation of the integrated machine, the access opening is closed by the cover plate, so as to prevent foreign matter from entering the housing and affecting the operation of various components in the housing.

Optionally, a paper monitor is provided at the paper outlet to detect an end of the paper, the film-cutting assembly and the actuator for film-cutting are connected to the paper monitor for transferring electrical signals.

By using the above-mentioned technical solution, the paper monitor is configured to monitor a position of an end edge of the paper. When the paper monitor monitors that the distance between the monitor and the end edge of the paper reaches a set distance, the position information of the paper at this time is recorded as zero point information, and the position information of the whole paper, i.e. the position of the paper at this time, may be obtained from the zero point information. The paper monitor sends out the zero point information, and the actuator for film-cutting drives the transfer rollers for film-cutting to move the paper in the direction close to the film-cutting assembly at a set speed. When the paper moves to a set position, the film-cutting assembly runs to perform an accurate film-cutting operation.

Optionally, a plurality of paper monitors are provided at the paper outlet, the plurality of paper monitors are arranged along a width direction of the paper and are parallel to each other.

By using the above-mentioned technical solution, the paper monitor is configured to detect the position of the end edge of the paper, and the plurality of paper monitors cooperate with each other to reduce an error. Since the plurality of paper monitors are parallel to each other in the width direction of the paper, distance information monitored by the two paper monitors should be consistent. When the distance information monitored by the plurality of paper monitors is inconsistent and has a large difference, it indicates that the paper is inclined or some of the paper monitors are damaged, at this time, the position of the paper shall be adjusted in time or the integrated machine shall be overhauled in time.

Optionally, the film-cutting assembly includes a film-cutting seat, a cutter head for film-cutting is slidably provided on the film-cutting seat, a film-cutting platform is provided below the cutter head for film-cutting, a first drive part is provided on the film-cutting seat to drive the cutter head for film-cutting to move in a direction close to the film-cutting platform, and a second drive part is provided in the housing to drive the film-cutting seat to move in an X-axis direction and a Y-axis direction.

By using the above-mentioned technical solution, when the film-cutting assembly performs a film-cutting operation, the film-cutting seat is driven to move in the X-axis direction and Y-axis direction by the second drive part, so that the film-cutting seat drives the cutter head for film-cutting to move to the position where the film-cutting needs to be performed. The first drive part then drives the cutter head for film-cutting to move down, so that the cutter head for film-cutting comes into contact with the lamination film of the paper to press the paper against the film-cutting platform. The second drive part runs in this process to move the cutter head for film-cutting, and the cutter head for film-cutting carries out a die cutting on the lamination film during the movement to form the required shape and specification of the lamination film, thereby completing the film-cutting process. The first drive part and the second drive part cooperate with each other, so as to accurately control the cutter head for film-cutting, thereby improving the precision of the film-cutting processing and reducing the film-cutting deviation.

Optionally, a drive monitor is provided on the second drive part, and the drive monitor is connected to the second drive part for transferring electrical signals.

By adopting the above-mentioned technical solution, the drive monitor on the second drive part is configured to detect the operation state of the second drive part, thereby monitoring the actual movement state of the film-cutting seat. When the drive monitor monitors that there is a deviation between the actual movement state and the theoretical movement state of the film-cutting seat, the drive monitor outputs a signal, and the second drive part acquires the signal and performs error compensation so as to reduce a film-cutting deviation.

Optionally, an air blowing seat is provided on the film-cutting seat, the air blowing seat is configured with an air blowing port, the air blowing port is vertically arranged and in communication with an outside, the film-cutting seat is configured with an air blowing member to convey air to the air blowing port.

By adopting the above-mentioned technical solution, the air blower is operated when the cutter head for film-cutting performs the film-cutting process, the air blower delivers air to the air blowing port through the air blowing seat, and the air is blown vertically downward onto the paper through the air blowing port, thereby avoiding the lamination film of the paper is taken up by the cutter head for film-cutting when cutting the film, which, as a result, affects the film-cutting process of the paper. On the other hand, since the gas is vertically blown out through the air blowing port, the vertical displacement of the paper may be restricted, which improves the stability of the paper in the film-cutting process.

In summary, the present disclosure includes at least one of the following beneficial technical effects:
1. The printing assembly and the film-cutting assembly are integrated together by the integrated machine of the present application, and the printing and film-cutting of the paper may be completed by the integrated machine. The integrated machine has a compact structure and occupies a small space, and is flexible and convenient to use. Under the premise that the user's field is limited, the use requirements may still be satisfied and the inconvenience caused to the user due to a restricted space may be avoided. In addition, when the paper only needs to be printed or undergo a film-cutting processing separately, which may be achieved by the integrated machine with high overall applicability.
2. The partition plate divides the space in the housing, so that the printing assembly and the transfer rollers for printing are located in the first channel, and when the printing assembly performs a printing processing on the paper, the paper moves in the first channel. When the printing processing on the paper is completed, the transfer rollers for film-cutting rotate to reciprocate the paper, so that the film-cutting assembly performs a film-cutting operation. As the paper moves in and out through the paper outlet, the paper is guided into the second channel by the first guide plate. The second channel provides a clean path for the paper to avoid interference on the paper by the printing assembly and transfer rollers for printing during film-cutting.
3. Two ends of the second guide plate which are obliquely provided may respectively guide the paper in two movement directions. After the printing process of the paper is finished, the transfer rollers for printing move the paper in the direction close to the film-cutting assembly, in this process, the end of the paper will come into contact with the second guide plate, such that the paper may more smoothly abut against the transfer rollers for film-cutting under the guidance of the second guide plate. When the paper is subjected to the film-cutting process, an end of the second guide plate close to the film-cutting assembly cooperates with the first guide plate to better guide the paper, which is convenient for the paper to enter into the second channel.

### BRIEF DESCRIPTION OF THE DRAWINGS

FIG. 1 is a schematic view showing the overall structure of the integrated thermal dye sublimation printing and film-cutting machine according to embodiment 1 of the present application;

FIG. 2 is a schematic sectional view of embodiment 1 of the present disclosure;

FIG. 3 is a sectional side view of embodiment 1 of the present application, herein, a printing assembly has finished printing a paper, the paper is undergoing a film-cutting operation, and transfer rollers for film-cutting clamp the paper to convey the paper;

FIG. 4 is an enlarged view of portion B in FIG. 3;

FIG. 5 is an enlarged view of portion A in FIG. 1;

FIG. 6 is a sectional side view of embodiment 1 of the present application, herein, the printing assembly is printing the paper, and transfer rollers for printing clamp the paper to convey the paper;

FIG. 7 is a sectional side view of embodiment 1 of the present application, herein, the printing assembly has finished the printing operation on the paper, the transfer rollers for printing convey the paper to the transfer rollers for film-cutting, one end of the paper is clamped by the transfer rollers for printing and the other end thereof is clamped by the transfer rollers for film-cutting;

FIG. 8 is a schematic view showing mounting positions of two paper monitors in embodiment 2 of the present application; and

FIG. 9 is a schematic sectional view of a cutter head for film-cutting in embodiment 2 of the present disclosure.

### DETAILED DESCRIPTION

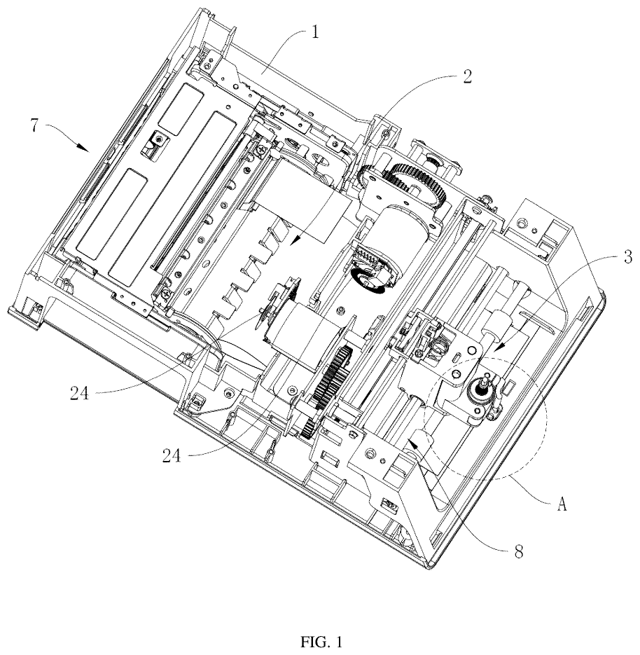

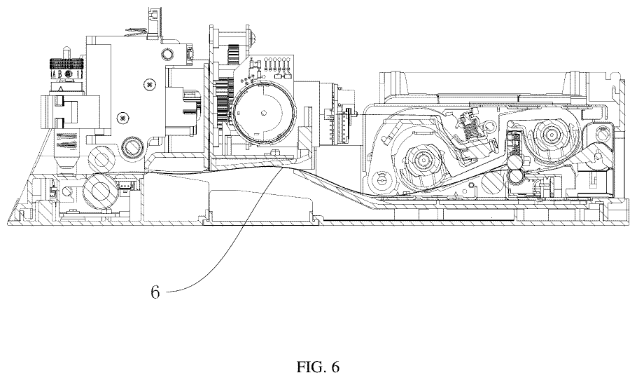

The present disclosure is further illustrated in combination with FIGS. 1-9.

### Embodiment 1

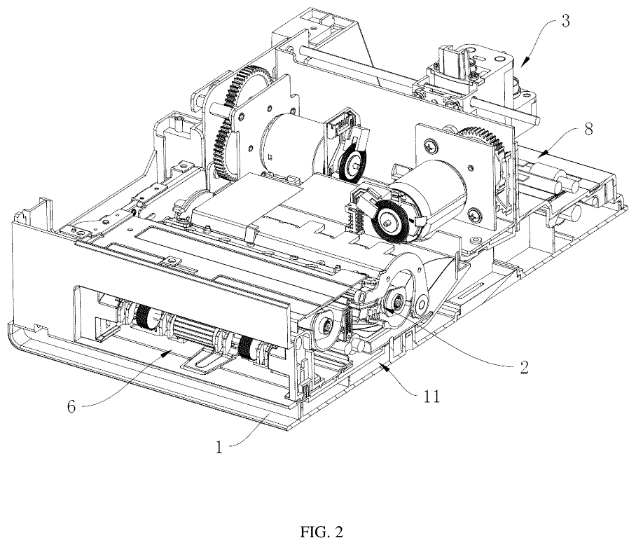

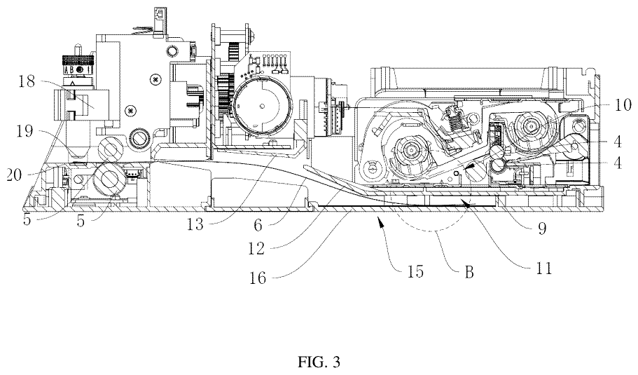

Embodiment 1 of the present application discloses an integrated thermal dye sublimation printing and film-cutting machine. With reference to FIGS. 1 and 2, the integrated thermal dye sublimation printing and film-cutting machine includes a housing 1, a printing assembly 2 and a film-cutting assembly 3 are provided in the housing 1. An end in the housing 1 close to the printing assembly 2 is rotatably provided with two transfer rollers for printing 4, an actuator for printing configured to rotate the transfer rollers for printing 4 is provided in the housing 1. An end in the housing 1 close to the film-cutting assembly 3 is rotatably provided with two transfer rollers for film-cutting 5, and an actuator for film-cutting configured to rotate the transfer rollers for film-cutting 5 is provided in the housing 1. Referring to FIGS. 2 and 3, the shortest distance between the transfer rollers for printing 4 and the transfer rollers for film-cutting 5 is less than a length of paper 6. A paper inlet 7 is defined at the end in the housing 1 close to the printing assembly 2, and a paper outlet 8 is provided at the end in the housing 1 close to the film-cutting assembly 3. The transfer rollers for printing 4, the printing assembly 2, the transfer rollers for film-cutting 5 and the film-cutting assembly 3 are successively arranged from the paper inlet 7 to the paper outlet 8, and the paper 6 successively enters between the two transfer rollers for printing 4 and between the two transfer rollers for film-cutting 5 through the paper inlet 7, and is out of the paper outlet 8.

Referring to FIG. 3, a partition plate 9 is horizontally provided in the housing 1, the partition plate 9 divides a space in the housing 1 into an upper first channel 10 and a lower second channel 11, and the printing assembly 2 and the transfer rollers for printing 4 are located in the first channel 10.

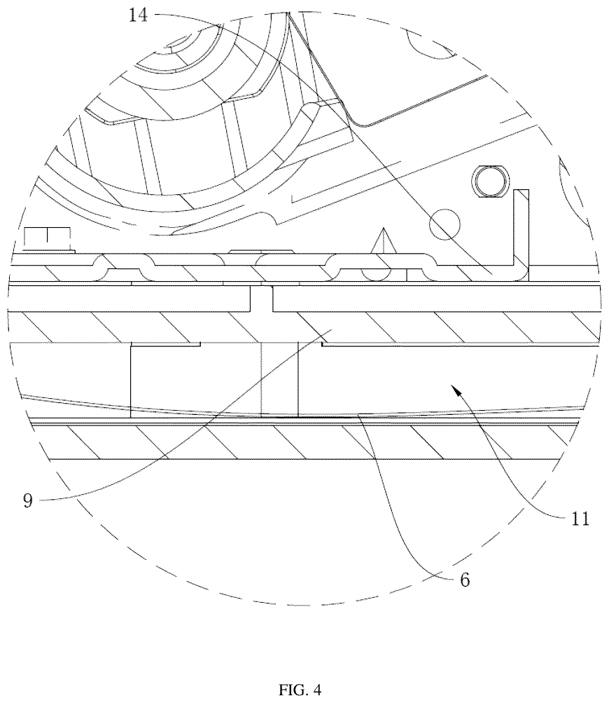

With reference to FIGS. 3 and 4, the partition plate 9 is integrally formed with a first guide plate 12 which extends obliquely, and the first guide plate 12 is widened in a direction towards one end close to the film-cutting assembly 3. A second guide plate 13 is provided in the first channel 10, one end of the second guide plate 13 is obliquely provided in a direction close to the printing assembly 2, and the other end thereof is extends in a same inclined direction as that of the first guide plate 12 and obliquely to the film-cutting assembly 3.

The partition plate 9 divides the space in the housing 1, so that the printing assembly 2 and the transfer rollers for printing 4 are located in the first channel 10, and when the printing assembly 2 performs a printing operation on the paper 6, the paper 6 moves in the first channel 10. When the printing operation on the paper 6 is completed, the transfer rollers for film-cutting 5 rotate to reciprocate the paper 6, so that the film-cutting assembly 3 performs a film-cutting operation. As the paper 6 moves back and forth through the paper outlet 8, the paper is guided into the second channel 11 by the first guide plate 12 and the second guide plate 13. The second channel 11 provides a clean path for the paper 6 to avoid interference on the paper by the printing assembly 2 and transfer rollers for printing 4 during film-cutting.

Referring to FIG. 4, an L-shaped top plate 14 is provided in the first channel 10 between the transfer rollers for printing 4 and the transfer rollers for film-cutting 5. The top plate 14 is configured to restrict the movement direction of the paper 6. When the paper 6 moves in the direction close to the transfer rollers for printing 4, in the case that the paper 6 moves into the first channel 10 by mistake, the end of the paper 6 will abut against the top plate 14, the top plate 14 limits the continued movement of the paper 6 in the same direction, and the end of the paper 6 will deform itself after abutting against the top plate 14 without continuing to move in the direction towards the transfer rollers for printing 4.

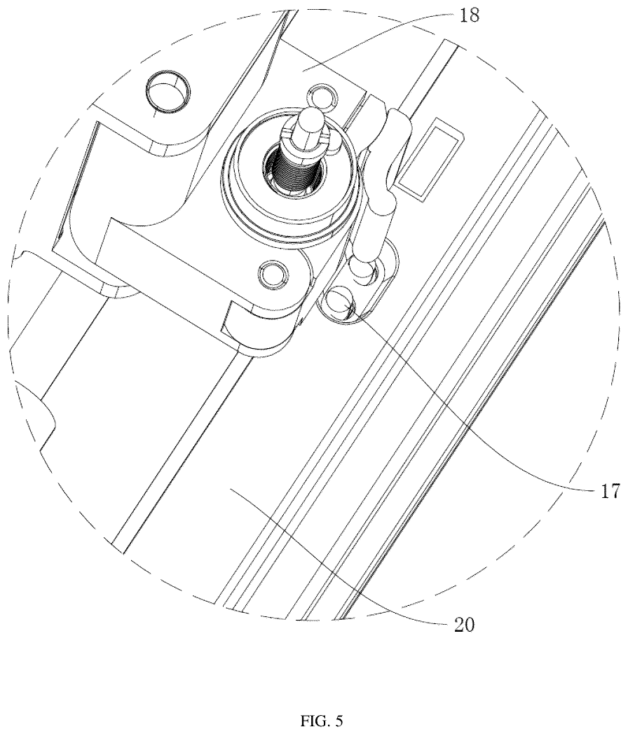

With reference to FIGS. 3 and 5, the film-cutting assembly 3 includes a film-cutting seat 18, a cutter head for film-cutting 19 is slidably provided on the film-cutting seat 18, a driver configured to drive the cutter head for film-cutting 19 to move in a Z-axis direction is provided on the film-cutting seat 18, and a film-cutting platform 20 is provided below the cutter head for film-cutting 19. The film-cutting seat 18 is provided with a first drive part for driving the cutter head for film-cutting 19 to move in a direction close to the film-cutting platform 20. A second drive part for driving the film-cutting seat 18 to move in an X-axis direction and the Y-axis direction is provided in the housing 1, a drive monitor is provided on the second drive part, and the drive monitor is connected to the second drive part for transferring electrical signals. When the film-cutting assembly 3 performs a film-cutting operation, the film-cutting seat 18 is driven to move in the X-axis direction and Y-axis direction by the second drive part, so that the film-cutting seat 18 moves the cutter head for film-cutting 19 to the position where the film-cutting needs to be performed. The first drive part then drives the cutter head for film-cutting 19 to move down, so that the cutter head for film-cutting 19 comes into contact with the lamination film of the paper 6 to press the paper 6 against the film-cutting platform 20. The second drive part runs in this process to move the cutter head for film-cutting 19, and the cutter head for film-cutting 19 carries out a die cutting on the lamination film during the movement, to form the required shape and specification of the lamination film, thereby completing the film-cutting process.

Referring to FIGS. 1 and 3, the film-cutting platform 20 is provided with a paper monitor 17 for detecting the end of the paper 6, and the film-cutting assembly 3 and the actuator for film-cutting are both connected to the paper monitor 17 for transferring electrical signals. The paper monitor 17 is configured to monitor a position of an end edge of the paper 6. When the paper monitor 17 monitors that the distance between the monitor and the end edge of the paper 6 reaches a set distance, the position information of the paper 6 at this time is recorded as zero point information, and the position information of the whole paper 6, i.e. the position of the paper 6 at this time, may be obtained from the zero point information. The paper monitor 17 sends out the zero point information, and the actuator for film-cutting drives the transfer rollers for film-cutting 5 to move the paper 6 in the direction close to the film-cutting assembly 3 at a set speed. When the paper 6 moves to a set position, the film-cutting assembly 3 runs to perform an accurate film-cutting operation.

Referring to FIG. 3, the housing 1 is configured with an access opening 15, the access opening 15 is located between the printing assembly 2 and the film-cutting assembly 3, and a cover plate 16 for closing the access opening 15 is detachably connected to the housing 1. The provision of the access opening 15 facilitates timely overhaul and maintenance of various components in the housing 1, and when a paper jam occurs accidentally in the housing 1, the paper may also be taken out through the access opening 15, so that the working convenience of the integrated machine is improved thereby. During the daily operation of the integrated machine, the access opening 15 is closed by the cover plate 16, so as to prevent foreign matter from entering the housing 1 and affecting the operation of various components in the housing 1.

The housing 1 includes a base and a cover, and various components in the integrated machine are arranged on the base. In the normal use of the integrated machine, the cover covers the base and closes the various components in the integrated machine, thereby preventing the various components in the integrated machine from being exposed directly to the outside and thus being vulnerable to knock. However, in the embodiment of the present application, in order to facilitate the representation of the various components in the integrated machine, the cover is not connected to the base.

Referring to FIGS. 1 and 2, in the embodiment of the present application, reference may be made to components in a conventional printer for the specific structure of the printing assembly 2. The first driving mechanism and the second driving mechanism are designed as a gear and a synchronous belt which cooperate with each other, so as to respectively drive the film-cutting seat 18 to move in the X-axis direction and Y-axis direction, and a drive source for driving the gear to rotate is designed as a direct current motor. The drive monitor is a coding disc 24 mounted on the direct current motor. An output shaft of the direct current motor rotates, to correspondingly move the film-cutting seat 18, and the coding disc 24 detects a rotation state of the output shaft of the direct current motor in this process and then monitors an actual movement state of the film-cutting seat 18. When the coding disc 24 detects a deviation between the actual movement state and a theoretical movement state of the film-cutting seat 18, the coding disc 24 outputs a signal, and a corresponding direct current motor acquires the signal and performs error compensation in time, thereby reducing film-cutting deviation.

In the embodiment of the present application, the actuator for printing and the actuator for film-cutting are both designed as motors of the same specification and model, an output shaft of each motor is coaxially and fixedly connected to a transfer roller, such that a rotation of the corresponding transfer roller is realized by the rotation of the output shaft of the motor.

The implementation principle of the integrated thermal dye sublimation printing and film-cutting machine in embodiment 1 of the present application is as follows. Referring to FIG.

6, when it is required to print and perform the film-cutting on the paper 6, the paper 6 is fed into the housing 1 through the paper inlet 7, such that the end of the paper 6 enters between the two transfer rollers for printing 4. Then the two transfer rollers for printing 4 are driven to rotate by the actuator for printing, such that the clamping and conveying of the paper 6 is realized by the rotation of the two transfer rollers for printing 4. The printing assembly 2 runs to print and laminate a film on the paper 6 during the conveyance of the paper 6. By the above-mentioned process, a movement direction of the paper 6 may be changed by changing the rotation direction of the transfer rollers for printing 4, so that the paper 6 is fed in and out to complete a reciprocating movement, and the printing assembly 2 thus performs multi-step operations on the paper 6 to complete the printing and the film lamination of the paper 6.

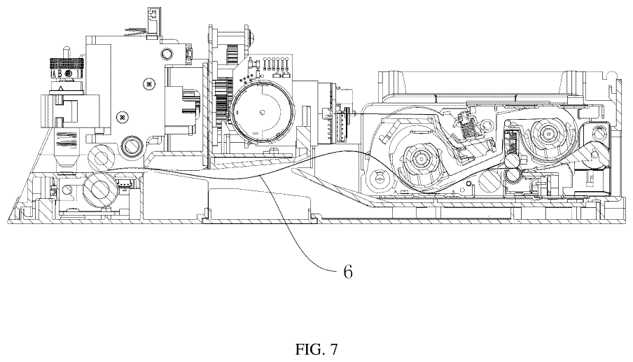

Referring to FIGS. 3 and 7, after the printing and film lamination of the paper 6 are completed, the transfer rollers for printing 4 rotate to move the paper 6 toward the transfer rollers for film-cutting 5, and when the end of the paper 6 arrives between the two transfer rollers for film-cutting 5, the actuator for film-cutting drives the transfer rollers for film-cutting 5 to rotate, and the clamping and conveying of the paper 6 are realized by the rotation of the transfer rollers for film-cutting 5, whereby the paper 6 moves in the direction close to the film-cutting assembly 3, and then the film-cutting assembly 3 runs to perform the film-cutting process on the paper 6. As the film-cutting assembly 3 runs, the end of the paper 6 leaves the transfer rollers for printing 4. The movement direction of the paper 6 may be changed by changing the rotation direction of the transfer rollers for film-cutting 5, such that the paper 6 may be moved out and in through the paper outlet 8 so as to perform a reciprocating movement, and the film-cutting assembly 3 may perform multi-step operations on the paper 6, thereby completing the film-cutting process of the paper 6.

After both the printing and the film-cutting process of the paper 6 are completed, the transfer rollers for film-cutting 5 rotate, to move the paper 6 out of the paper outlet 8, thereby completing all the processing of the paper 6. Since the shortest distance between the transfer rollers for printing 4 and the transfer rollers for film-cutting 5 is less than the length of the paper 6, the paper 6 does not leave the transfer rollers for printing 4 and/or the transfer rollers for film-cutting 5 during the entire conveyance of the paper 6, whereby a stable conveyance of the paper 6 is achieved, which prevents the paper 6 from falling into the housing 1.

### Embodiment 2

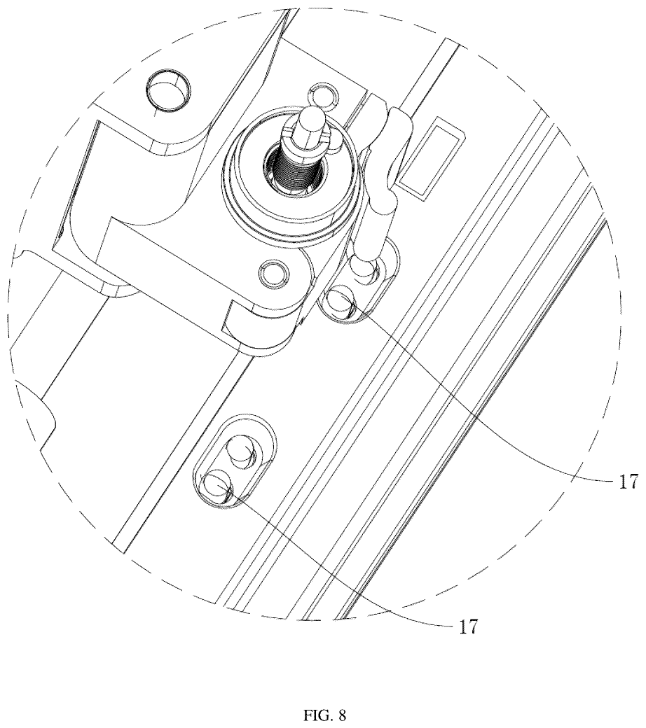

Embodiment 2 differs from embodiment 1 in that, referring to FIG. 8, two paper monitors 17 are provided at the paper outlet 8, and the two paper monitors 17 are arranged in a width direction of the paper 6 and parallel to each other.

The paper monitor 17 is configured to detect the position of the end edge of the paper 6, and the two paper monitors 17 cooperate with each other to reduce an error. Since the two paper monitors 17 are parallel to each other in the width direction of the paper 6, distance information monitored by the two paper monitors 17 should be consistent. When the distance information monitored by the two paper monitors 17 is inconsistent and has a large difference, it indicates that the paper 6 is inclined or some of the paper monitors 17 are damaged, at this time, the position of the paper 6 shall be adjusted in time or the integrated machine shall be overhauled.

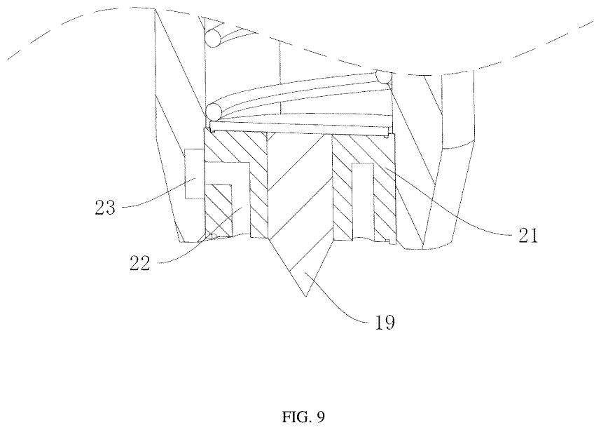

With reference to FIG. 9, the film-cutting seat 18 is provided with an air blowing seat 21, the air blowing seat 21 is configured with an air blowing port 22, and the air blowing port 22 is arranged vertically and in communication with the outside. The film-cutting seat 18 is provided with an air blowing member for delivering air to the air blowing port 22.

In the embodiment of the present application, the air blowing member is designed as a small air blower 23, and an air outlet of the air blower 23 is communication with the air blowing port 22, thereby delivering air to the air blowing port 22.

The implementation principle of embodiment 2 is that the air blower 23 is operated when the cutter head for film-cutting 19 performs the film-cutting process, the air blower 23 delivers air to the air blowing port 22 through the air blowing seat 21, and the air is blown vertically downward onto the paper 6 through the air blowing port 22, thereby avoiding the lamination film of the paper 6 is taken up by the cutter head for film-cutting 19 when cutting the film, which, as a result, affects the film-cutting process of the paper 6. On the other hand, since the gas is vertically blown out through the air blowing port 22, the vertical displacement of the paper 6 may be restricted, which improves the stability of the paper 6 in the film-cutting process.

The foregoing contents are preferred embodiments of the present disclosure, and are not intended to limit the protection scope of the present disclosure. Any equivalent changes made according to the structure, shape and principle of the present disclosure are to be embraced within the scope of protection of the present disclosure.

### LIST OF REFERENCE NUMERALS

1 housing
2 printing assembly
3 film-cutting assembly
4 transfer roller for printing
5 transfer roller for film-cutting
6 paper
7 paper inlet
8 paper outlet
9 partition plate
10 first channel
11 second channel
12 first guide plate
13 second guide plate
14 top plate
15 access opening
16 cover plate
17 paper monitor
18 film-cutting seat
19 cutter head for film-cutting
20 film-cutting platform
21 air blowing seat
22 air blowing port
23 air blower
24 coding disc

What is claimed is:

1. An integrated thermal dye sublimation printing and film-cutting machine, comprising a housing, wherein a printing assembly and a film-cutting assembly are provided in the housing, a first end in the housing close to the printing assembly is rotatably provided with two transfer rollers for printing, an actuator for printing is provided in the housing to rotate the two transfer rollers for printing, a second end in the housing close to the film-cutting assembly is rotatably provided with two transfer rollers for film-cutting, an actuator for film-cutting is provided in the housing to rotate the two transfer rollers for film-cutting, a shortest distance between the two transfer rollers for printing and the two transfer rollers for film-cutting is less than a length of a paper, a paper inlet is defined at the first end in the housing, a paper outlet is defined at the second end in the housing, and the paper is configured to successively enter between the two transfer rollers for printing and between the two transfer rollers for film-cutting through the paper inlet and move out through the paper outlet.

2. The integrated thermal dye sublimation printing and film-cutting machine according to claim 1, wherein a partition plate is provided in the housing, the partition plate divides a space in the housing into a first channel and a second channel, the printing assembly and the two transfer rollers for printing are located in the first channel, a first guide plate is obliquely provided on the partition plate, and the first guide plate is widened to an end close to the film-cutting assembly.

3. The integrated thermal dye sublimation printing and film-cutting machine according to claim 2, wherein a second guide plate is provided in the first channel, a first end of the second guide plate extends obliquely in a direction to the printing assembly, and a second end of the second guide plate extends in a same inclined direction as an inclined direction of the first guide plate and extends obliquely to the film-cutting assembly.

4. The integrated thermal dye sublimation printing and film-cutting machine according to claim 2, wherein a top plate is provided in the first channel, and the top plate is located between the two transfer rollers for printing and the two transfer rollers for film-cutting.

5. The integrated thermal dye sublimation printing and film-cutting machine according to claim 1, wherein an access opening is defined at the housing, the access opening is located between the printing assembly and the film-cutting assembly, and a cover plate is detachably connected to the housing to close the access opening.

6. The integrated thermal dye sublimation printing and film-cutting machine according to claim 1, wherein a paper monitor is provided at the paper outlet to detect an end of the paper, and the film-cutting assembly and the actuator for film-cutting are both connected to the paper monitor for transferring electrical signals.

7. The integrated thermal dye sublimation printing and film-cutting machine according to claim 6, wherein a plurality of paper monitors are provided at the paper outlet, and the plurality of paper monitors are arranged along a width direction of the paper and are parallel to each other.

8. The integrated thermal dye sublimation printing and film-cutting machine according to claim 1, wherein the film-cutting assembly comprises a film-cutting seat, a cutter head for film-cutting is slidably provided on the film-cutting seat, a film-cutting platform is provided below the cutter head for film-cutting, a first drive part is provided on the film-cutting seat to drive the cutter head for film-cutting to move in a direction close to the film-cutting platform, and a second drive part is provided in the housing to drive the film-cutting seat to move in an X-axis direction and a Y-axis direction.

9. The integrated thermal dye sublimation printing and film-cutting machine according to claim 8, wherein a drive monitor is provided on the second drive part, and the drive monitor is connected to the second drive part for transferring electrical signals.

10. The integrated thermal dye sublimation printing and film-cutting machine according to claim 8, wherein an air blowing seat is provided on the film-cutting seat, the air blowing seat is configured with an air blowing port, the air blowing port is vertically arranged and in communication with outside of the integrated thermal dye sublimation printing and film-cutting machine, and the film-cutting seat is configured with an air blowing member to convey air to the air blowing port.
